(19) United States
(12) Patent Application Publication
(10) Pub. No.: US 2016/0264047 A1
(43) Pub. Date: Sep. 15, 2016

(54) SYSTEMS AND METHODS FOR A PASSING LANE VEHICLE REAR APPROACH ALERT

(71) Applicant: GM GLOBAL TECHNOLOGY OPERATIONS LLC, Detroit, MI (US)

(72) Inventors: SHIV PATEL, BRAMPTON (CA); MUNIB AHMED YUSUF, SCARBOROUGH (CA); AAMRAPALI CHATTERJEE, OKEMOS, MI (US); LI JI, NORTHVILLE, MI (US)

(21) Appl. No.: 14/656,373

(22) Filed: Mar. 12, 2015

(51) Int. Cl. B60Q 9/00; G06K 9/00; B60R 1/00

(52) U.S. Cl. CPC B60Q 9/008; B60R 1/00; G06K 9/00791

(57) ABSTRACT

A method and system for alerting a passing lane driver of a vehicle rear approach is provided. The method and system is enabled when the host vehicle is in a passing lane. The method and system initiates a readily comprehensible alert to the driver. The provided method and system further accepts user input for customization, enabling/disabling, and terminating an alert.

### TECHNICAL FIELD

The technical field generally relates to vehicle safety systems, and more particularly relates to systems and methods for a passing lane vehicle rear approach alert.

### BACKGROUND

Many jurisdictions assign roadways with roadway classifications, and codify rules associated with the roadway classifications, in effort to ensure safe traveling on the roadways. An example of a roadway classification is a multi-lane highway, and an example of a codified rule associated with a multi-lane highway, in jurisdictions where drivers are required to drive on the right side of the road, is the requirement to keep to the right except to pass another vehicle.

Multi-lane highways or freeways are generally designed to support high-speed traffic. With few exceptions, the left-most lane in a multi-lane highway is a lane reserved for passing (the “passing lane”). A host vehicle traveling, for reasons other than passing a vehicle, in the passing lane of a high-speed multi-lane highway may be problematic for vehicles approaching from the rear. For this reason, many jurisdictions penalize drivers for driving in the passing lane if such driving inhibits traffic approaching from the rear of the host vehicle and the driver could safely move the host vehicle out of the passing lane (in jurisdictions in which drivers are required to travel on the left side of the road, the right-most lane is typically the passing lane, and the same observations may be made). Therefore, it may be desirable to alert a driver in the passing lane of a high-speed roadway that a vehicle is approaching from the rear.

Accordingly, a method and system for alerting a passing lane driver of a vehicle rear approach is desirable. The desired method and system is enabled when the host vehicle is in a passing lane on a multi-lane highway and is traveling at or above an associated predetermined speed. The desired method and system initiates a readily comprehensible alert to the driver. The desired method and system further accepts user input for customization, enabling/disabling the system, and terminating an alert. Furthermore, other desirable features and characteristics of the present invention will be apparent from the subsequent detailed description and the appended claims, taken in conjunction with the accompanying drawings and the foregoing technical field and background.

### SUMMARY

This summary is provided to introduce a selection of concepts in a simplified form that are further described below in the detailed description section. This summary is not intended to identify key features or essential features of the claimed subject matter, nor is it intended to be used as an aid in determining the scope of the claimed subject matter.

Accordingly, a method for use in a vehicle safety system for a host vehicle is provided. The method comprises: processing host vehicle position and host vehicle movement to determine when the host vehicle is moving; processing information from a forward looking camera system coupled to the host vehicle and configured to detect a first vehicle in a region in front of the host vehicle; and, processing information from sensors configured to detect a second vehicle in an area behind the host vehicle. When the host vehicle is moving, and the first vehicle is not detected in the region in front of the host vehicle, an alert is initiated when the second vehicle is detected in the area behind the host vehicle.

A vehicle safety system for a host vehicle is also provided. The system comprises a forward looking camera system configured to detect a first vehicle in a region in front of the host vehicle; a sensor system configured to detect a second vehicle in an area behind the host vehicle; a source of location information; and a processor coupled to the forward looking camera system, the sensor system and the source of location information. The processor is configured to (i) receive a host vehicle position and a host vehicle movement, (ii) determine whether the host vehicle is in a passing lane; and (iii) initiate an alert when the following conditions are satisfied: (a) the host vehicle is in the passing lane, (b) the first vehicle is not detected in the region in front of the host vehicle, and (c) the second vehicle is detected in the area behind the host vehicle.

Also provided is another method for use in a vehicle safety system for a host vehicle. The method comprises: obtaining a host vehicle position and a host vehicle movement; receiving, from a source of location information, high definition map data; processing high definition map data, host vehicle position and host vehicle movement to determine whether the host vehicle is moving in a passing lane; processing information from a forward looking camera system coupled to the host vehicle and configured to detect a first vehicle in a region in front of the host vehicle; and, processing information from sensors configured to detect a second vehicle in an area behind the host vehicle. When the host vehicle is moving in a passing lane, and a first vehicle is not detected in the region in front of the host vehicle, the method initiates an alert when the second vehicle is detected in the area behind the host vehicle.

### DESCRIPTION OF THE DRAWINGS

A more complete understanding of the subject matter may be derived from the following detailed description taken in conjunction with the accompanying drawings, wherein, like reference numerals denote like elements, and:

FIG. 1 is a simplified system diagram depicting a host vehicle, according to an exemplary embodiment;

FIG. 2 is block diagram showing a vehicle rear approach alert system, in accordance with an exemplary embodiment;

FIG. 3 is a flow chart describing steps of a vehicle rear approach alert process, in accordance with an exemplary embodiment;

FIG. 4 is a continuation of the flow chart of FIG. 3; and

FIG. 5 is an illustration of a portion of a forward looking view from within a host vehicle dashboard, showing various alert options provided by the exemplary embodiment.

### DETAILED DESCRIPTION

The following Detailed Description is merely exemplary in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over any other implementations. Furthermore, there is no intention to be bound by any expressed or implied theory presented in the preceding Technical Field, Background, Brief Summary or the following Detailed Description.

Techniques and technologies may be described herein in terms of functional and/or logical block components and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

The following descriptions may refer to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements, additional intervening elements, devices, features, or components may be present in an embodiment of the depicted subject matter. In addition, certain terminology may also be used in the following description for the purpose of reference only, and thus are not intended to be limiting.

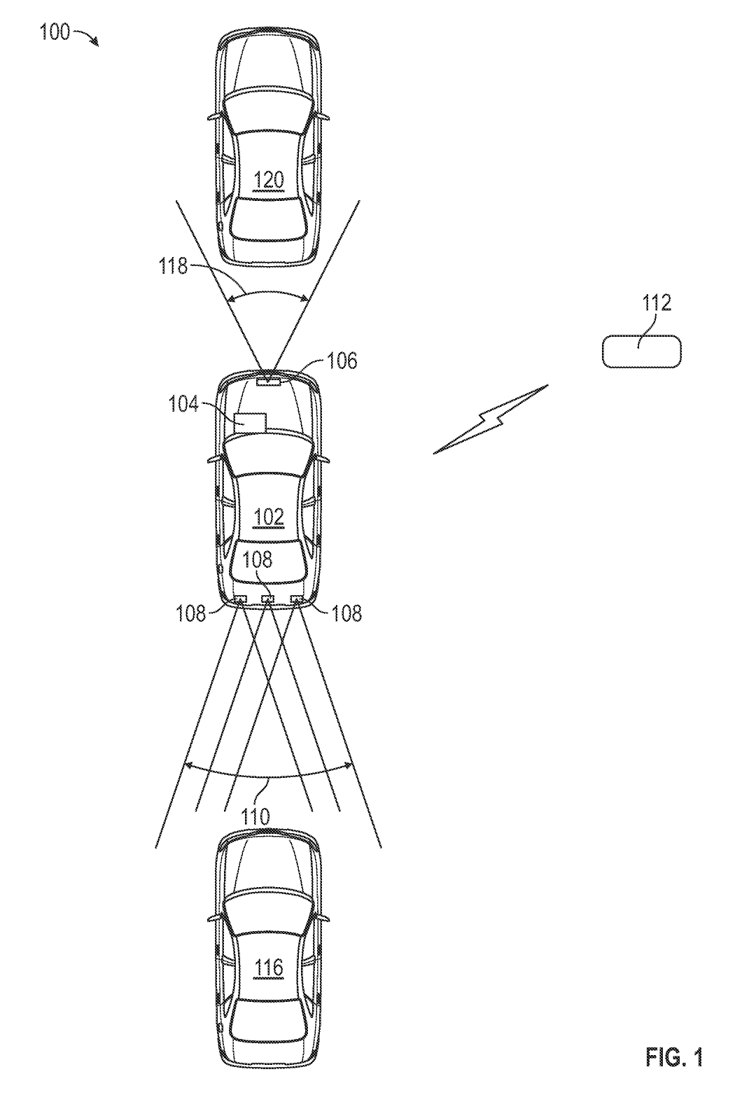

FIG. 1 is a simplified system diagram 100 depicting a host vehicle 102 according to an exemplary embodiment. Vehicle rear approach alert system 104 is installed in host vehicle 102. In the exemplary embodiment, a forward looking camera system 106 is located on the host vehicle 102, configured to monitor a region 118 in front of host vehicle 102, and a sensor system 108 is located in the back of the host vehicle 102, and configured to monitor an area 110 behind the host vehicle 102. A wireless signal source 112 is in operative communication with the vehicle rear approach alert system 104 of host vehicle 102. Vehicle 120 (referred to hereinafter as the first vehicle) is located in the region 118 in front of host vehicle 102 and vehicle 116 (referred to hereinafter as the second vehicle) is depicted as being in the area 110 behind the host vehicle 102. In the exemplary embodiment, a “vehicle in front” refers to a vehicle on the same lane as the host vehicle 102.

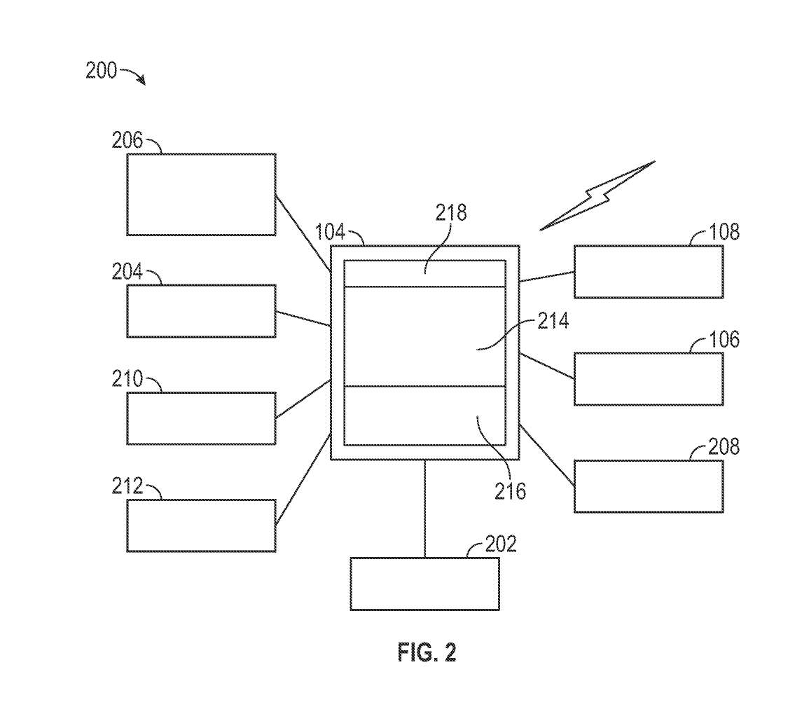

FIG. 2 is block diagram 200 showing a vehicle rear approach alert system 104 in accordance with an exemplary embodiment. Advantageously, vehicle rear approach alert system 104 is operatively coupled to existing host vehicle 102 systems, such as, forward looking camera system 106, sensor system 108, user input device 202, display device 204, vehicle management system 206, and an optional database 208. Vehicle rear approach alert system 104 may also be operatively coupled to audio device 210 and vehicle hardware 212. Vehicle rear approach alert system 104 includes at least one processor 214, memory 216, and a wireless transceiver 218.

During operation, vehicle rear approach alert system 104 continuously receives and processes data from wireless transceiver 218, camera system 106, sensor system 108, and vehicle management system 206. These systems are described in connection with the exemplary embodiment in more detail below.

Wireless transceiver 218, in turn, may continuously receive location information, such as host vehicle position, in the form of geographic positioning system (GPS) data, high definition map data, jurisdictionally relevant roadway information, and the like, from sources such as the wireless signal source 112. The location information is generally obtained from wireless signals, but may be obtained, at least in part, from optional database 208. High definition maps included in the location information typically provide roadway identifications, and each roadway identification may additionally have its associated roadway classification, lane count, passing lane designations, speed limits, and the like, attached (for example, in the form of a data structure). Alternatively, some or all of the roadway information may be obtained from optional database 208, which may reside onboard the host vehicle 102 or external to it. Vehicle rear approach alert system 104 processes the wireless information and location information in the determination of whether the host vehicle 102 is in a passing lane on a multi-lane highway.

To the extent possible, vehicle rear approach alert system 104 may cooperate with, and leverage features of, an already existing vehicle safety system. The forward looking camera system 106 may be part of the existing vehicle safety system. The camera system 106 is used to detect whether there is an object (for example, the first vehicle 120) in a region 118 in front of the host vehicle 102. Information from camera system 106 may also be employed in determining whether the host vehicle 102 is in a passing lane on a multi-lane highway. Camera system 106 is configured to monitor a region 118 in front of the host vehicle 102. In some embodiments, front detection in the camera system 106 is performed, or enhanced, by detection devices (not shown), such as: forward oriented long-range, medium-range or short-range radars, Lidar, or vehicle-to-vehicle (V2V) communication, also configured to detect objects in region 118 in front of the host vehicle.

Region 118 may be defined in various ways, and is configurable via user input. Region 118 is generally a volume extending forward from the front bumper of the host vehicle 102, and may be wide enough to extend beyond the lane that the host vehicle 102 is positioned in. One way to define the region 118 in front of the host vehicle is by identifying a “time to collision” parameter (TtC). TtC is an amount of time that will pass before the host vehicle 102, traveling at a given speed, would collide with an object in front of it. Some embodiments set a default value of TtC of substantially three seconds. TtC may become a more complex calculation (i.e., a dynamic calculation) when the object in front of the host vehicle 102 is also moving, in which case, TtC is a function of several variables including the speeds of the host vehicle 102 and the object in front (generally, first vehicle 120).

Sensor system 108 may also be part of the existing vehicle safety system. Alternatively, sensor system 108 may represent additional on-board radar, configured to dynamically detect whether a second vehicle 116 is in an area behind the host vehicle 102. Sensor system 108 may comprise any combination of short, medium, or long range radar devices, as well as a rear facing smart camera, and these devices may be distributed in multiple positions on host vehicle 102. In some embodiments, sensor system 108 provides the host vehicle 102 with speed and acceleration information about the second vehicle 116, allowing the vehicle rear approach alert system 104 to, not only alert the driver of the presence of the second vehicle 116, but also prioritize its aggressiveness or urgency, for embodiments that provide alerts with various priorities.

In one embodiment, vehicle management system 206 is part of the existing vehicle safety system, and includes onboard instrumentation and sensors, such as global positioning system (GPS) unit, vehicle speed and equipment sensors, and the like. In some embodiments, wireless transceiver 218 is part of the vehicle management system 206. Host vehicle movement, such as speed and acceleration, is obtained by the vehicle management system 206.

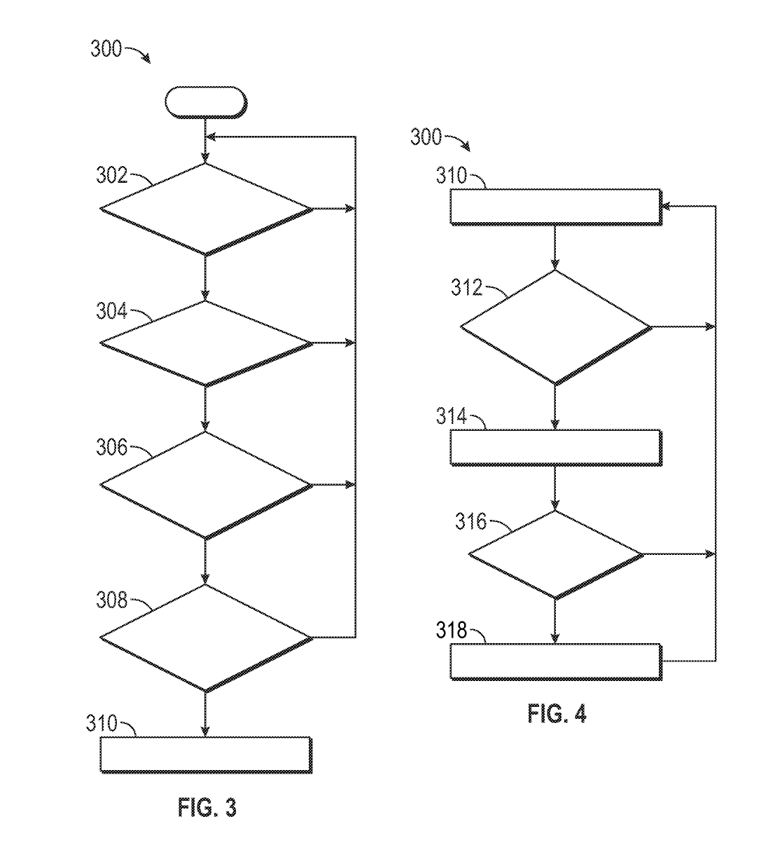

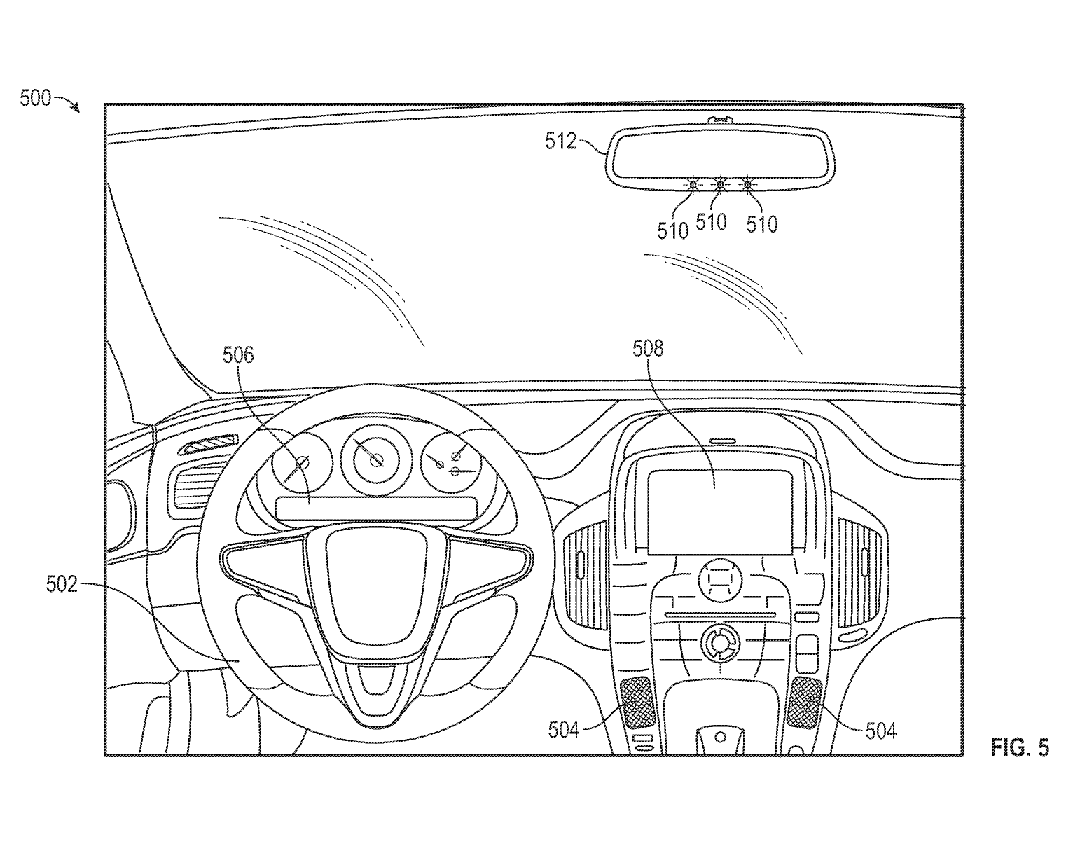

During operation, vehicle rear approach alert system 104 additionally monitors and responds to user input provided by user input device 202. The user input device 202 may be realized as one or more of: a keypad, touchpad, keyboard, mouse, touchscreen, joystick, knob, microphone, speech recognition device, gesture interpretation device or another suitable device adapted to receive input from a user within the host vehicle 102. The user input includes criteria such as a static or dynamic “time to collision” (TtC), minimum predetermined speed for enabling the vehicle rear approach alert system 104, ranges and dimensions for areas to monitor in front of or behind the vehicle, threshold speeds for creation of priority alert levels, etc. Adjustments responsive to user input are performed by the processor 214. The process associated with the vehicle rear approach alert system 104 is described in more detail in connection with FIG. 3 and FIG. 4.

Alerts may be one or any combination of visual, aural or tactile. Accordingly, to initiate an alert, the processor 214 is configured to command and control one or more of display device 204, audio device 210 and vehicle hardware 212. In the exemplary embodiment, an alert is continuous until it is terminated. Termination of an alert is described in connection with STEP 318 in FIG. 4.

Display device 204 may include any form of image-generating devices suitable for use in the host vehicle's 102 already existing dashboard, mirrors, or driver information center (DIC). Examples of suitable display devices include light emitting diodes (LEDs), various analog (e.g., cathode ray tube) and digital (e.g., liquid crystal, active matrix, plasma, etc.) display devices. As such, the display device 204 may be disposed at various locations throughout the host vehicle 102. Processor 214 may provide the display device 204 with any combination of textual and non-textual information, such as the illumination of LEDs, presentation of alpha-numeric information, presentation of composite images in a two dimensional format, three dimensional format (e.g., as a perspective display), or in a hybrid format (e.g., in a picture-in-picture or split screen arrangement).

In one embodiment, audio device 210 is part of the existing audio system of the host vehicle 102, and is capable of emitting an audible sound and/or synthesized voice command. Accordingly, audio device 210 may also be disposed at various locations throughout the host vehicle 102.

Vehicle hardware 212 includes the existing steering wheel system, brake pedal, gas pedal, gear shaft, driver's seat, or any other hardware feature of the host vehicle 102 deemed appropriate for providing the driver with vibrational or other haptic feedback as an alert.

In addition to what is depicted in FIG. 2, processor 214 may comprise, or be associated with, any suitable number of individual microprocessors, memories, power supplies, storage devices, interface cards, and other standard components known in the art. In this respect, the processor 214 may include or cooperate with any number of software programs (e.g., existing vehicle safety systems) or instructions designed to carry out the various methods, process tasks, calculations, and control/display functions described below.

FIG. 3 is a flow chart describing steps of a vehicle rear approach alert process 300, in accordance with an exemplary embodiment. As one skilled in the art will appreciate, the steps of process 300 may be organized in a different order, and steps may be added or subtracted without departing from the spirit of the invention. The steps of process 300 are performed in processor 214. As described in connection with FIG. 2, the vehicle rear approach alert system 104 is continually receiving input from various subsystems and components.

At STEP 302, process 300 determines whether the host vehicle 102 is moving, and, further, if the host vehicle is moving (traveling) on a multi-lane highway by processing host vehicle position, host vehicle movement, and roadway identification and classification. Host vehicle 102 position includes host vehicle location and host vehicle orientation; this information may be sourced from a GPS device that resides on-board or external to the host vehicle. Host vehicle 102 movement includes speed and acceleration, which may be sourced from host vehicle speed sensors, accelerometers, and/or GPS information. In some embodiments, data from an on-board camera system 106 is also processed in STEP 302.

In some embodiments, the definition of a multi-lane highway is a roadway classification codified by the prevailing jurisdiction. Roadway classifications, such as multi-lane highway classifications, often include a set of characteristics; examples of such characteristics include: dividing opposing lanes of traffic, min/max travel speed limits, minimum elevation grades, minimums for turn angles and banking, separation of exits and on-ramps, etc. In some embodiments, a plurality of said roadway characteristics is organized as one string of data (i.e., a data structure) associated with or attached to a respective roadway identification. Accordingly, process 300 may initially rely on high definition maps for roadway identification, and then extract a roadway classification from a data structure associated with the roadway identification. Process 300 then may compare the position of the host vehicle 102 with characteristics from the high definition map information to determine whether the host vehicle is traveling on a multi-lane highway. In an alternative, process 300 may receive a user-generated definition of a multi-lane highway via user input device 202 for this determination.

At STEP 304 process 300 determines whether the host vehicle is traveling faster than a minimum predetermined speed. In some embodiments, the minimum predetermined speed is the slowest traveling speed permitted in a given lane, assigned by law, to the roadway or the road classification associated with the roadway. The minimum speed may be a posted minimum speed limit, representative of a minimum safe travel speed associated with the respective roadway. In the exemplary embodiment, the minimum predetermined speed is sixty miles per hour, but minimum predetermined speed is configurable via wireless updates and user input. Similar to STEP 302, the minimum predetermined speed may be obtained by process 300 by extracting it from a data structure associated with the roadway identification in the high definition maps, or by user input. In the exemplary embodiment, the vehicle management system 206 provides the processor 214 with the host vehicle speed, in response, the processor 214 determines whether the host vehicle is traveling faster than the minimum predetermined speed.

At STEP 306, process 300 determines whether the host vehicle is in a passing lane. With few exceptions, the left-most lane in a multi-lane highway is referred to as a passing lane because it is a lane reserved for use by a vehicle to safely pass a slower moving vehicle. Passing lane definitions typically exclude high occupancy vehicle (HOV) lanes and left exit lanes in cases where passing lanes are the left-most lane. Conversely, in jurisdictions where drivers are required to keep left while driving, passing lanes may be the right-most lanes excluding HOV or exit lanes. As with STEP 302 and STEP 304, passing lane information may be user supplied or extracted from a data structure associated with the roadway identification that was obtained wirelessly or from a database. Jurisdictionally relevant information, wirelessly received, may be processed to adjust roadway information (such as the location of passing lanes) to accommodate road construction, weather, accidents, damaged roads, law enforcement operations, or the like. Process 300 compares passing lane information with vehicle position and location information to determine whether a host vehicle 102 is in a passing lane. In some embodiments, processor 214 may rely on information from the forward looking camera system 106 for data at STEP 306.

At STEP 308, process 300 determines whether there is a vehicle in a region 118 in front of host vehicle 102. The “front” of host vehicle 102 is understood to occupy, at a minimum, the width of the host vehicle and extending forward an average car length. The detection of an object, such as a vehicle, “in front” of host vehicle 102 is performed by one of the following devices: front camera module, medium/long range radar, Lidar or V2V communication. The length of the “region in front” (region 118) of the host vehicle 102 may extend forward as far as the technology of the sensor devices and/or the forward looking camera is operable. The size, location, and shape of region 118 are, therefore, configurable. As mentioned above, the size of region 118 may be a function of a (static or dynamic) variable called time to collision (TtC). The forward looking camera system 106 monitors region 118 to detect objects in region 118 in front of the host vehicle 102. In some embodiments, one or more radar sensors may be included in camera system 106 and relied upon for this determination. Region 118 is continuously monitored for the presence of an object (specifically, first vehicle 120).

The definition of a “vehicle” is user configurable, and/or may be provided by a optional database 208. The exemplary embodiment defines “vehicle” to include motorcycles as well as automobiles commercial delivery vehicles, busses, and the like. Process 300 processes data and information from camera system 106 to determine whether there is a vehicle in a region 118 in front of host vehicle 102.

At STEP 310, process 300 is enabled. As is depicted in the flowchart of FIG. 3, at each of STEPS 302-306, when the determination is negative, process 300 returns to STEP 302. At STEP 308, if the determination is positive, process 300 returns to STEP 302. It is contemplated that the order of STEPS 302-308 may be shuffled, and that process 300 may be enabled with any one or more of STEPS 302-308.

FIG. 4 is a continuation of the flow chart of FIG. 3. When process 300 is enabled (STEP 310), the process advances to STEP 312 wherein it continually monitors an area 110 behind the host vehicle to determine whether a second vehicle 116 is in the area 110 behind the host vehicle 102. At STEP 312, when a second vehicle 116 is not detected in the area behind the host vehicle 102, a previously initiated alert may be terminated. As with the region in front of the host vehicle 102, the area behind the host vehicle is configurable in size and shape. While the process 300 is enabled, it continues to monitor the area 110 behind the host vehicle (STEP 312). As described above, monitoring the area 110 behind the host vehicle 102 is provided by sensor system 108; sensor system 108 typically embodies one or more radar devices, and/or a rear facing smart camera, configured to detect the presence of a second vehicle in an area 110, and provide processor 214 with associated data and information.

When a rear approach vehicle (i.e., a second vehicle 116) is detected, process 300 initiates an alert to the driver (STEP 314). As described above, alerts may one or any combination of visual, aural, or haptic. In addition, process 300 may detect additional contextual information and distinguish alerts accordingly; for example, the speed and acceleration of the second vehicle 116 may be detected to assign the rear approaching second vehicle 116 with an aggressiveness or urgency. Example priority levels may be low-medium-high, red-yellow-green, or any similarly intuitive scheme.

STEP 316 checks for a driver acknowledgment of the alert. At STEP 318, in response to a driver acknowledgment of the alert, process 300 terminates the alert. If the driver does not acknowledge the alert, process 300 returns to STEP 310. Driver acknowledgement may occur in several ways. Driver acknowledgment may be provided via a user input device 202, and may involve a touch to a touch-screen, a voice command, a gesture, a button touch or manipulation, or the like. Additionally, driver acknowledgment may be the driver physically moving the host vehicle 102 out of the passing lane.

STEPS 312-318 only occur when process 300 is enabled. In addition to the enabling steps described, user input may override process 300 and disable it.

FIG. 5 is an illustration of a forward looking view 500 from within a host vehicle, showing examples of alert options provided by the exemplary embodiment. The examples shown in FIG. 5 are for illustration only, and are not limiting. Steering wheel 502 may vibrate, and/or speakers 504 may emit an audible alert. In addition, any combination of display options may be employed, for example alphanumeric message “left lane for passing only,” depicted on the dash at 506, and “approaching rear vehicle,” located on the driver information center 508. Light emitting diodes (LEDs) 510, placed in a readily viewable area, such as the rear view mirror 512, may be illuminated. As may be appreciated by one skilled in the art, other devices and methods for alerting the driver may be employed while remaining within the spirit of the invention.

Thus, there has been provided a method and system for alerting a passing lane driver of a vehicle rear approach. The method and system is enabled when the host vehicle is in a passing lane. The provided method and system further accepts user input for customization, enabling/disabling, and terminating an alert.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for use in a vehicle safety system for a host vehicle, the method comprising:
processing host vehicle position and host vehicle movement to determine when the host vehicle is moving;
processing information from a forward looking camera system coupled to the host vehicle and configured to detect a first vehicle in a region in front of the host vehicle;
processing information from sensors configured to detect a second vehicle in an area behind the host vehicle, and
when the host vehicle is moving, and the first vehicle is not detected in the region in front of the host vehicle,
initiating an alert when the second vehicle is detected in the area behind the host vehicle.

2. The method of claim 1, further comprising:
receiving, from a source of location information, high definition map data; and
processing the high definition map data to determine whether the host vehicle is in a passing lane; and
wherein the step of initiating the alert comprises initiating the alert only on the further condition that the host vehicle is in the passing lane.

3. The method of claim 2, further comprising:
processing the high definition map data to determine when the host vehicle is on a roadway classified as a multi-lane highway; and
wherein the step of initiating the alert comprises initiating the alert only on the further condition that the host vehicle is on a roadway classified as a multi-lane highway.

4. The method of claim 3, further comprising:
receiving, from a vehicle management system, a host vehicle speed; and
processing the host vehicle speed to determine when the host vehicle speed is greater than a predetermined minimum speed; and
wherein the step of initiating the alert comprises initiating the alert only on the further condition that the host vehicle speed is greater than the predetermined minimum speed.

5. The method of claim 1, further comprising:
providing the host vehicle with a radar device configured to transmit and receive radar information into the area behind the host vehicle; and
wherein processing the sensor information comprises processing the radar information.

6. The method of claim 1, wherein initiating the alert comprises at least one of:
illuminating a LED device, rendering symbology on a display device, providing haptic feedback on vehicle hardware, and emitting an audible alert from an audio device.

7. The method of claim 2, further comprising, upon initiating the alert, terminating the alert in response to receiving user input associated with the alert.

8. The method of claim 2, further comprising, upon initiating the alert, terminating the alert when the second vehicle is not detected in the area behind the host vehicle or when the host vehicle moves out of the passing lane.

9. A system for vehicle safety system for a host vehicle, comprising:
a forward looking camera system configured to detect a first vehicle in a region in front of the host vehicle;
a sensor system configured to detect a second vehicle in an area behind the host vehicle;
a source of location information; and
a processor coupled to the forward looking camera system, the sensor system and the source of location information and configured to
(i) receive a host vehicle position and a host vehicle movement;
(ii) determine whether the host vehicle is in a passing lane; and
(iii) initiate an alert when the following conditions are satisfied:
(a) the host vehicle is in the passing lane,
(b) the first vehicle is not detected in the region in front of the host vehicle, and
(c) the second vehicle is detected in the area behind the host vehicle.

10. The system of claim 9, wherein the processor is further configured to (i) process the location information to determine when the host vehicle is on a multi-lane highway, and (ii) initiate the alert only when the following conditions are satisfied:
(a) the host vehicle is in the passing lane,
(b) the first vehicle is not detected in the region in front of the host vehicle,
(c) the second vehicle is detected in the area behind the host vehicle, and
(d) the host vehicle is on a multi-lane highway.

11. The system of claim 10, further comprising:
a vehicle management system coupled to the processor and configured to provide host vehicle speed, and wherein the processor is configured to initiate the alert only on the further condition that the host vehicle speed is at least the predetermined minimum speed.

12. The system of claim 10, wherein the sensor system comprises a radar device configured to transmit and receive radar information into the area behind the host vehicle.

13. The system of claim 10, wherein the processor is further coupled to an existing driver information center having a display, and wherein initiating the alert comprises generating symbology on the driver information center.

14. The system of claim 10, wherein the processor is further coupled to a LED device configured to be viewable by a driver of the host vehicle while driving, and wherein initiating the alert comprises illuminating the LED device.

15. The system of claim 10, further comprising an audio device coupled to the processor, and wherein initiating the alert comprises commanding the audio device to emit an audible alert.

16. The system of claim 10, wherein the processor is further coupled to vehicle hardware and further configured to command the vehicle hardware to generate haptic feedback.

17. The system of claim 10, further comprising:
a user input device coupled to the processor and configured to receive user input, and wherein the processor is further configured to, upon initiating an alert, terminate the alert upon receiving user input associated with the alert.

18. The system of claim 10, wherein the processor is further configured to, upon initiating an alert, terminate the alert when the second vehicle is not detected in the area behind the host vehicle or when the host vehicle moves out of the passing lane.

19. A method for use in a vehicle safety system for a host vehicle, the method comprising:
obtaining a host vehicle position and a host vehicle movement;
receiving, from a source of location information, high definition map data;
processing high definition map data, host vehicle position and host vehicle movement to determine whether the host vehicle is moving in a passing lane;
processing information from a forward looking camera system coupled to the host vehicle and configured to detect a first vehicle in a region in front of the host vehicle;
processing information from sensors configured to detect a second vehicle in an area behind the host vehicle, and
when the host vehicle is moving in a passing lane, and a first vehicle is not detected in the region in front of the host vehicle,
initiating an alert when the second vehicle is detected in the area behind the host vehicle.

20. The method of claim 19, further comprising:
receiving, from a vehicle management system, host vehicle speed; and
processing the host vehicle speed to determine when the host vehicle speed is greater than a predetermined minimum speed; and
wherein the step of initiating an alert comprises initiating the alert only on the further condition that the host vehicle is speed is greater than the predetermined minimum speed.
